(19) United States
(12) Patent Application Publication
(10) Pub. No.: US 2025/0367721 A1
(43) Pub. Date: Dec. 4, 2025

(54) ELECTRODE SHEET FABRICATION DEVICE

(71) Applicants: Prime Planet Energy & Solutions, Inc., Tokyo (JP); JTEKT CORPORATION, Aichi-ken (JP)

(72) Inventors: Shinji YOSHIOKA, Himeji-shi (JP); Toshiatsu ODAI, Himeji-shi (JP); Daichi UMINO, Himeji-shi (JP); Hideki NAGANO, Nagoya-shi (JP)

(21) Appl. No.: 19/207,357

(22) Filed: May 14, 2025

(30) Foreign Application Priority Data
May 28, 2024 (JP) 2024-086699

(51) Int. Cl. B21B 37/46; B21B 1/24; B21B 39/02

(52) U.S. Cl. CPC B21B 37/46; B21B 1/24; B21B 39/02

(57) ABSTRACT

An electrode sheet fabrication device includes a support roll that supports an electrode sheet, a pressing roll which faces the support roll with the electrode sheet sandwiched between the pressing roll and the support roll and at least whose outer circumference surface is made of rubber, and a controller. In the controller, a movement controller moves the pressing roll from a first position at which the pressing roll is separated from the electrode sheet toward a second position at which the pressing roll contacts the electrode sheet before conveyance of the electrode sheet starts. The conveyance controller conveys the electrode sheet after the pressing roll has moved to the second position. The pressing controller presses the pressing roll against the electrode sheet from the second position when conveyance of the electrode sheet is started or when a reference time has elapsed since conveyance of the electrode sheet was started.

### CROSS REFERENCE TO RELATED APPLICATIONS

This application claims the benefit of priority to Japanese Patent No. 2024-086699 filed on May 28, 2024. The entire contents of this application are hereby incorporated herein by reference.

### BACKGROUND

The present disclosure relates to an electrode sheet fabrication device.

Japanese Patent Application Publication No. 2023-36089, for example, discloses a method for fabricating an electrode. In this method, in a precursor sheet (i.e., an electrode sheet) including metal foil, a coated portion coated with an electrode material on the metal foil, and an uncoated portion not coated with the electrode material on the metal foil, the uncoated portion is pressed by a pair of elastic rolls (i.e., rubber rolls).

For example, when the uncoated portion is pressed with rolls other than elastic rolls, voids can occur by a tensile force or other reasons inside the uncoated portion. These voids might cause breakage of the uncoated portion. By pressing the uncoated portion with the pair of elastic rolls, a compressive force and a deformation force can be applied to the same portion of the uncoated portion. This compressive force occurs by deformation of the elastic rolls caused by contact with the pair of elastic rolls. Accordingly, the uncoated portion can be extended with suppression of breakage of the uncoated portion.

### SUMMARY

In the method for fabricating an electrode disclosed in Japanese Patent Application Publication No. 2023-36089, when the elastic rolls are kept pressed against the precursor sheet, pressed portions of the elastic rolls can be locally deformed. When the locally deformed elastic rolls rotate and are pressed against an uncoated portion, the degree of extension of the uncoated portion might vary.

An electrode sheet fabrication device disclosed here is a fabrication device that fabricates an electrode sheet including a current collector of long metal foil, a non-formed portion defined along a length direction at a predetermined position in a width direction in the current collector, and an electrode active material layer located on a portion of the current collector except for the non-formed portion and including an electrode active material. The fabrication device includes: a conveyor that conveys the electrode sheet along a predetermined conveyance path; a support roll that is located on the conveyance path and supports, along the width direction, a first surface of the electrode sheet conveyed along the conveyance path; a pressing roll located at a second surface of the electrode sheet and facing the support roll; a driver that presses the pressing roll against the support roll with the electrode sheet sandwiched between the pressing roll and the support roll; and a controller. The pressing roll is a rubber roll at least whose outer circumference surface is made of rubber and is located such that the non-formed portion is sandwiched between the pressing roll and the support roll except for the electrode active material layer of the electrode sheet. The driver includes a moving mechanism and a pressing mechanism. The moving mechanism moves the pressing roll to a first position at which the pressing roll is separated from the electrode sheet and a second position at which the pressing roll contacts the electrode sheet. The pressing mechanism that presses the pressing roll against the electrode sheet from the second position. The controller includes a movement controller, a conveyance controller, and a pressing controller. The movement controller that moves the pressing roll from the first position toward the second position before the conveyor starts conveyance of the electrode sheet. The conveyance controller that conveys the electrode sheet along the support roll after the pressing roll has moved to the second position by the movement controller. The pressing controller that presses the pressing roll against the electrode sheet from the second position when the conveyance controller starts conveyance of the electrode sheet or when a predetermined reference time has elapsed since the conveyance controller started conveyance of the electrode sheet.

In the electrode sheet fabrication device disclosed here, after the pressing roll has been located at the second position, conveyance of the electrode sheet is started. Then, when conveyance of the electrode sheet is started or when a reference time has elapsed since conveyance of the electrode sheet was started, the pressing roll is pressed against the electrode sheet from the second position. Accordingly, the timing of pressing the pressing roll against the electrode sheet from the second position is delayed, and thus, the pressing roll is less likely to be locally deformed. As a result, the uncoated portion of the electrode sheet can be pressed by using the pressing roll that is less likely to be locally deformed and the support roll, and thus, the uncoated portion can be easily extended uniformly.

### BRIEF DESCRIPTION OF THE DRAWINGS

FIG. 1 is a flowchart of fabrication by an electrode sheet fabrication device.

FIG. 2 is a schematic view of an electrode sheet.

FIG. 3 is a schematic side view of the electrode sheet fabrication device.

FIG. 4 is a front view of a roll pressing machine.

FIG. 5 is a cross-sectional view taken along line A-A in FIG. 4.

FIG. 6 illustrates a state where pressing rolls are located at a first position and corresponds to FIG. 5.

FIG. 7 illustrates a state where the pressing rolls are located at a second position and a press cylinder is off, and corresponds to FIG. 5.

FIG. 8 is a block diagram of the electrode sheet fabrication device.

FIG. 9 is a flowchart showing a procedure of a pretreatment.

### DETAILED DESCRIPTION

A preferred embodiment of the technique disclosed here will be described hereinafter with reference to the drawings. The preferred embodiment described herein is, of course, not intended to particularly limit the present disclosure. Each drawing is a schematic view and does not necessarily strictly reflect an actual product. Members and parts having the same functions are denoted by the same reference numerals as appropriate, and description for the same members and parts will not be repeated as appropriate.

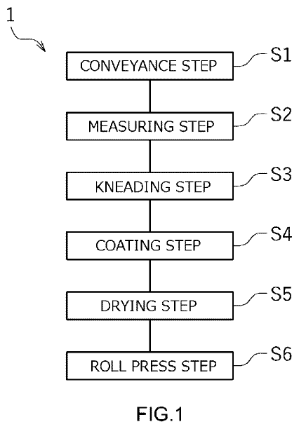

FIG. 1 is a flowchart of fabrication by an electrode sheet fabrication device 1. As illustrated in FIG. 1, fabrication in the electrode sheet fabrication device 1 includes conveyance step S1, measuring step S2, kneading step S3, coating step S4, drying step S5, and roll press step S6. The fabrication in the electrode sheet fabrication device 1 may include other steps.

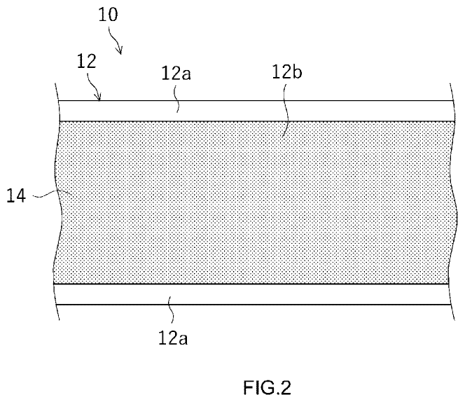

In the electrode sheet fabrication device 1, an electrode sheet 10 (see FIG. 2) constituting a power storage device is fabricated. The electrode sheet 10 includes a positive electrode sheet or a negative electrode sheet of an electrode body housed inside the power storage device. The power storage device refers to a device enabling repetitive charging and discharging, and generally includes so-called storage batteries (i.e., chemical cells) such as a lithium ion secondary battery, a nickel hydrogen battery, and a nickel-cadmium battery and capacitors (i.e., physical cells) such as an electric double layer capacitor. Hereinafter, as an example, the electrode sheet fabrication device 1 that fabricates an electrode sheet 10 will be described together with a configuration of the electrode sheet 10 for use in lithium ion secondary batteries.

FIG. 2 is a schematic view of the electrode sheet 10. As illustrated in FIG. 2, the electrode sheet 10 has an elongated band shape. The electrode sheet 10 includes a current collector 12 and an electrode active material layer 14. The current collector 12 is a member of metal foil. The current collector 12 is an elongated band-shaped metal member. As the current collector 12, a metal material having required conductivity can be used. As positive electrode current collecting foil as an example of the current collector 12, aluminium or an aluminium alloy can be used, for example. As negative electrode current collecting foil as another example of the current collector 12, copper or a copper alloy can be used, for example. The electrode active material layer 14 is applied onto a predetermined portion of the current collector 12. The electrode active material layer 14 is formed on at least one surface of the band-shaped current collector 12. In this preferred embodiment, the electrode active material layer 14 is formed on each surface of the current collector 12. The electrode active material layer 14 contains an electrode active material. As a positive electrode active material that is an example of the electrode active material, a lithium transition metal composite oxide can be used, for example. As a negative electrode active material that is an example of the electrode active material, a carbon material, a silicon-based material, and a mixed oxide thereof can be used, for example. The electrode active material layer may include an additive other than the electrode active material layer, such as a binder or a conductive material.

The electrode sheet 10 is formed by applying electrode mixture slurry as the electrode active material layer 14 onto the current collector 12 and drying the slurry. The current collector 12 includes uncoated portions 12a and a coated portion 12b. The uncoated portions 12a are an example of a non-formed portion. The uncoated portions 12a are portions of the current collector 12 not coated with the electrode active material layer 14. The uncoated portions 12a are defined at predetermined positions of the current collector 12 in the width direction along the length direction. The uncoated portions 12a are defined along the length direction on end portions of the electrode sheet 10 in the width direction. In this preferred embodiment, the uncoated portions 12a are defined at both ends of the electrode sheet 10 in the width direction. The coated portion 12b is located between the uncoated portions 12a at both ends of the electrode sheet 10. The coated portion 12b is a portion of the current collector 12 coated with the electrode active material layer 14. The electrode mixture slurry is applied onto the coated portion 12b. In this manner, the electrode active material layer 14 is formed on the coated portion 12b of the current collector 12. That is, the electrode active material layer 14 is located between the uncoated portions 12a at both ends of the electrode sheet 10 in the width direction. The electrode active material layer 14 is formed on a portion of the current collector 12 except for the uncoated portions 12a. Although not shown, a protective layer including an inorganic filler may be located at the boundary between the uncoated portions 12a and the coated portion 12b. In the case where the protective layer is formed, when rubber rolls of EPS are pressed against the protective layer, elongation percentages of a portion with the protective layer and a portion without the protective layer might not match.

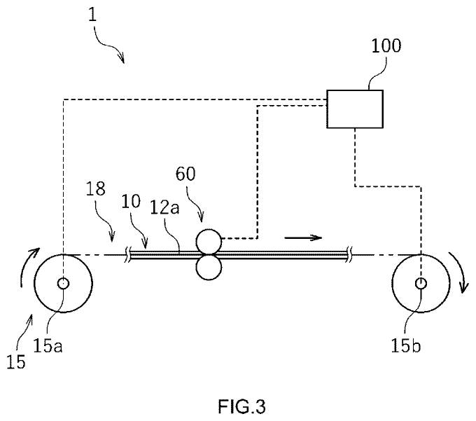

In conveyance step S1 shown in FIG. 1, the electrode sheet 10 is conveyed. FIG. 3 is a schematic side view of the electrode sheet fabrication device 1. In this preferred embodiment, the electrode sheet fabrication device 1 includes a conveyor 15. The conveyance step S1 can be implemented by the conveyor 15. The conveyor 15 conveys the electrode sheet 10. The conveyor 15 employs, for example, a motor. The conveyor 15 includes an unwinding roll 15a and a winding roll 15b such that the electrode sheet 10 is conveyed at a predetermined conveyance speed. The electrode sheet 10 is wound around the unwinding roll 15a and the winding roll 15b. The unwinding roll 15a is disposed upstream of a roll pressing machine 60 described later in the conveyance direction. The winding roll 15b is disposed downstream of the roll pressing machine 60 in the conveyance direction. The conveyor 15 is not limited to the configuration including the unwinding roll 15a and the winding roll 15b. For example, the conveyor 15 may include a roll other than the unwinding roll 15a and the winding roll 15b. The conveyor 15 conveys the electrode sheet 10 along a predetermined conveyance path 18.

In measuring step S2 shown in FIG. 1, materials for the electrode active material layer 14 (see FIG. 2) are measured. The measurement can be achieved using a measuring device (not shown) equipped with, for example, a balance or a load cell. The measured materials for the measured electrode active material layer 14 are mixed in kneading step S3. Kneading step S3 can be achieved by a kneading device (not shown). A material for the electrode active material layer 14 made into slurry by the kneading device is applied onto the current collector 12 (see FIG. 2) by coating in coating step S4. Coating step S4 can be achieved by, for example, a coating device (not shown) such as a slit coater, a gravure coater, a die coater, or a comma coater. In drying step S5 shown in FIG. 1, the applied slurry materials for the electrode active material layer 14 are dried. Drying step S5 can be achieved by a drying device (not shown) that emits, for example, hot air or an infrared ray.

In roll press step S6 shown in FIG. 1, the electrode sheet 10 is pressed. The electrode sheet 10 is extended by pressing. The roll press step S6 can be achieved by the roll pressing machine 60 shown in FIG. 3. The electrode sheet fabrication device 1 includes the roll pressing machine 60. As illustrated in FIG. 3, the electrode sheet 10 is pressed by the roll pressing machine 60 in the middle of the conveyance path 18. The electrode sheet 10 is supplied to the roll pressing machine 60 by the unwinding roll 15a. The electrode sheet 10 pressed by the roll pressing machine 60 is conveyed toward the winding roll 15b and wound by the winding roll 15b. The electrode sheet fabrication device 1 includes a controller 100 that controls the unwinding roll 15a, the winding roll 15b, and the roll pressing machine 60.

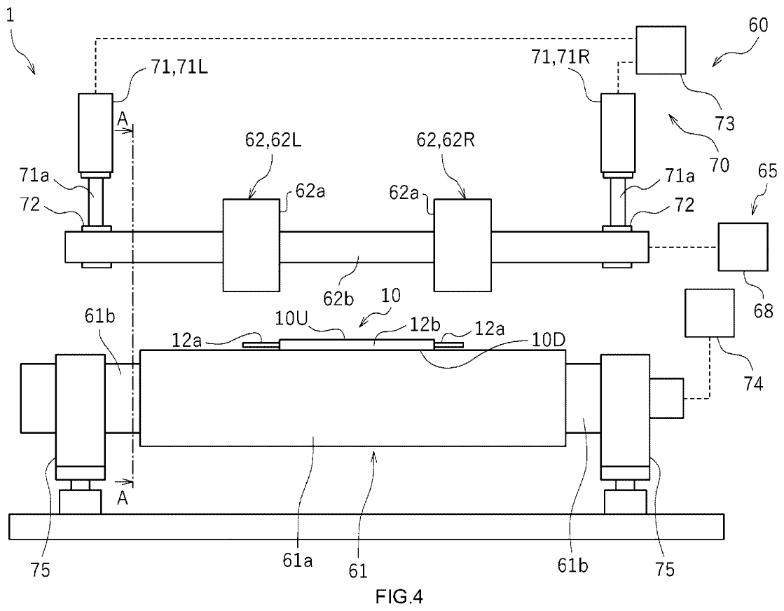

FIG. 4 is a front view of the roll pressing machine 60. The roll pressing machine 60 according to this preferred embodiment presses the uncoated portions 12a of the electrode sheet 10 by rubber rolls before or after the coated portion 12b of the electrode sheet 10 is pressed. When the uncoated portions 12a are pressed by the rubber rolls, under a reaction force of elastic deformation and compressive deformation of the rubber rolls, the portion pressed by the rubber rolls are pressed and pulled. Consequently, the uncoated portions 12a can be extended with breakage of the uncoated portions 12a suppressed. For this function, the device that presses the uncoated portions 12a of the electrode sheet 10 by the rubber rolls can be referred to as an elasticity powered stretching (EPS) device. The electrode sheet fabrication device 1 may include a device that presses the coated portion 12b, other than the roll pressing machine 60.

As illustrated in FIG. 4, the roll pressing machine 60 includes a support roll 61, the pressing rolls 62, and a driver 65.

The support roll 61 is located on the conveyance path 18 (see FIG. 3). The support roll 61 supports a first surface 10D of the electrode sheet 10 conveyed along the conveyance path 18, along the width direction of the electrode sheet 10. The electrode sheet 10 includes the first surface 10D and a second surface 10U. In this preferred embodiment, the first surface 10D constitutes a lower surface of the electrode sheet 10. The second surface 10U is a surface of the electrode sheet 10 opposite to the first surface 10D. In this preferred embodiment, the second surface 10U constitutes an upper surface of the electrode sheet 10. The support roll 61 is located below the pressing rolls 62. The support roll 61 is a rubber roll that presses the uncoated portions 12a of the electrode sheet 10 together with the pressing rolls 62. In this preferred embodiment, the support roll 61 includes a body 61a and both axial portions 61b.

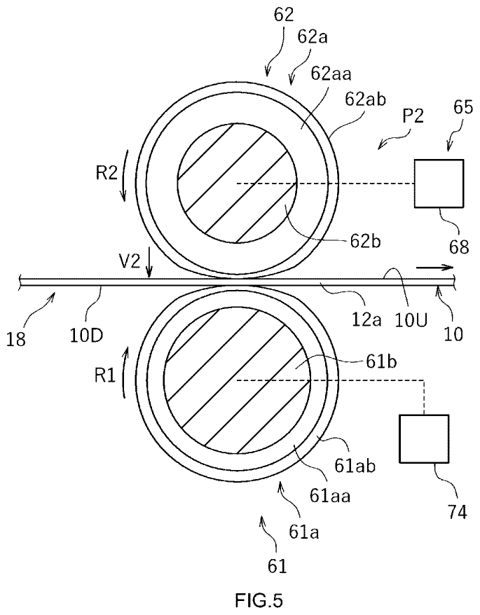

FIG. 5 is a cross-sectional view taken along line A-A in FIG. 4. FIG. 5 illustrates a state where the uncoated portions 12a are pressed by the support roll 61 and the pressing rolls 62. In FIG. 5, the pressing rolls 62 are at a second position P2 and press cylinders 71 described later (see FIG. 4) are on. As illustrated in FIG. 5, the body 61a includes an axis portion 61aa and a rubber portion 61ab. The axis portion 61aa is made of a metal. A material for the axis portion 61aa is not particularly limited, and is, for example, a material having a relatively high hardness such as SUS304 (stainless steel material). The rubber portion 61ab covers at least the outer circumference surface of the axis portion 61aa. A material for the rubber portion 61ab is, for example, nitrile rubber (NBR). The support roll 61 presses the uncoated portions 12a of the electrode sheet 10 with the rubber portion 61ab.

The support roll 61 rotates in a predetermined direction by a rotation mechanism 74 described later (see FIG. 4). In this preferred embodiment, the support roll 61 rotates in a direction of arrow R1 shown in FIG. 5. At this time, the electrode sheet 10 is conveyed from the left to the right when seen in the drawing of FIG. 5. That is, in FIG. 5, the left is an upstream side in the conveyance direction, and the right is a downstream side in the conveyance direction.

As illustrated in FIG. 4, the both axial portions 61b are inserted in the body 61a. The both axial portions 61b are inserted in the axis portion 61aa (see FIG. 5) of the body 61a. The both axial portions 61b extend to the outside of the support roll 61 in the axial direction. Although not shown, a bearing and a gap screw that adjusts a gap between the support roll 61 and the pressing rolls 62, for example, may be attached to the both axial portions 61b.

As illustrated in FIG. 5, the pressing rolls 62 press the electrode sheet 10 against the support roll 61. The pressing rolls 62 are disposed to face the support roll 61 on the second surface 10U (upper surface in this preferred embodiment) of the electrode sheet 10. The pressing rolls 62 sandwich the uncoated portions 12a between the pressing rolls 62 and the support roll 61 except for the coated portion 12b (see FIG. 2) of the electrode sheet 10. In this preferred embodiment, the positions of the axial centers of the pressing rolls 62 and the position of the axial center of the support roll 61 are aligned in the top-bottom direction. As illustrated in FIG. 4, the pressing rolls 62 are rubber rolls at least whose outer circumference surfaces are made of rubber. The pressing rolls 62 are rubber rolls that press the uncoated portions 12a of the electrode sheet 10 together with the support roll 61. The pressing rolls 62 are not located above the coated portion 12b of the electrode sheet 10. In this preferred embodiment, as described above, two uncoated portions 12a of the electrode sheet 10 are defined at both ends of the electrode sheet 10 in the width direction. Thus, as illustrated in FIG. 4, the pressing rolls 62 are respectively located above the uncoated portions 12a at both ends of the electrode sheet 10 in the width direction. The number of the pressing rolls 62 is two. The number of the uncoated portions 12a may be one. In the case where the number of the uncoated portions 12a is one, the number of the pressing rolls 62 may be one. In the two pressing rolls 62, the left pressing roll 62 will also be referred to as a pressing roll 62L, and the right pressing roll 62 will also be referred to as a pressing roll 62R. In the case where the description applies to both pressing rolls 62L and 62R, the term “pressing roll 62” will be used as appropriate. In this preferred embodiment, the pressing roll 62 includes the body 62a and the both axial portions 62b.

As illustrated in FIG. 5, the body 62a includes an axis portion 62aa and a rubber portion 62ab. The axis portion 62aa is made of a metal. A material for the axis portion 62aa is not particularly limited, and is, for example, a material having a relatively high hardness such as SUS304 (stainless steel material). The rubber portion 62ab covers at least the outer circumference surface of the axis portion 62aa. A material for the rubber portion 62ab is not particularly limited and is, for example, nitrile rubber (NBR). The pressing roll 62 presses the uncoated portion 12a of the electrode sheet 10 with the rubber portion 62ab.

As illustrated in FIG. 4, the both axial portions 62b are inserted in the body 62a. The both axial portion 62b is inserted in the axis portion 62aa (see FIG. 5) of the body 62a. The both axial portions 62b extend to the outside of the two pressing rolls 62 in the axial direction. Although not shown, a bearing and a gap screw that adjusts a gap between the support roll 61 and the pressing rolls 62, for example, are attached to the both axial portions 62b.

As illustrated in FIG. 5, when the support roll 61 rotates in the direction of arrow R1 with the electrode sheet 10 sandwiched between the support roll 61 and the pressing rolls 62, the pressing rolls 62 are subjected to a force of rotation in the direction of arrow R2 through the electrode sheet 10. On the other hand, when the support roll 61 and the pressing rolls 62 are in contact with each other without the electrode sheet 10, the pressing rolls 62 are subjected to a force of rotation in the direction of arrow R2 by the rotation force of the support roll 61. Accordingly, the pressing rolls 62 rotate in the direction of arrow R2. That is, the pressing rolls 62 are driven rolls that rotate in synchronization with rotation of the support roll 61.

The driver 65 presses the pressing rolls 62 against the support roll 61 with the electrode sheet 10 sandwiched between the pressing rolls 62 and the support roll 61. In this example, as illustrated in FIG. 4, the driver 65 includes a moving mechanism 68 and a pressing mechanism 70.

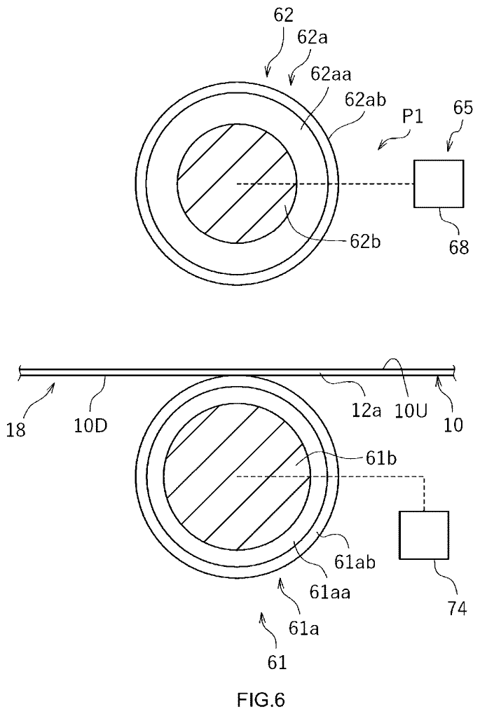

FIG. 6 illustrates a state where the pressing rolls 62 are located at a first position P1 and corresponds to FIG. 5. The moving mechanism 68 moves the pressing rolls 62 to the first position P1 (see FIG. 6) and the second position P2 (see FIG. 5). The first position P1 and the second position P2 herein are positions of the pressing rolls 62 with respect to the support roll 61 (e.g., the electrode sheet 10 supposed by the support roll 61). The first position P1 is a position of the pressing rolls 62 when the pressing rolls 62 are separated from the electrode sheet 10 supported by the support roll 61, as illustrated in FIG. 6. At the first position P1, the pressing rolls 62 are located above the support roll 61 and separated from the support roll 61. The second position P2 is a position of the pressing rolls 62 when the pressing rolls 62 contact the electrode sheet 10 supported by the support roll 61, as illustrated in FIG. 5. At the second position P2, the pressing rolls 62 contact the second surface 10U of the electrode sheet 10. The second position P2 is located below the first position P1. At the second position P2, the pressing rolls 62 are mounted on the electrode sheet 10 by self weight. While the electrode sheet 10 is not supported by the support roll 61 and the pressing rolls 62 are at the second position P2, the pressing rolls 62 are in contact with the support roll 61. In this preferred embodiment, the moving mechanism 68 moves the pressing rolls 62 between the first position P1 and the second position P2. The moving mechanism 68 also moves the pressing rolls 62 upward and downward. The configuration of the moving mechanism 68 is not particularly limited, and may be integrated with press cylinders 71 described later (see FIG. 4) or may be the press cylinders 71. For example, the moving mechanism 68 may be configured to move the pressing rolls 62 along rods 71a described later of the press cylinders 71.

As illustrated in FIG. 4, the pressing mechanism 70 presses the pressing rolls 62 against the electrode sheet 10. The pressing mechanism 70 adjusts a force (i.e., pressing force) with which the pressing rolls 62 press the electrode sheet 10. The pressing mechanism 70 includes the press cylinders 71, roll chocks 72, and a cylinder driving device 73.

The press cylinder 71 presses the pressing rolls 62 against the support roll 61. One press cylinder 71 is disposed on each outer side of one of both ends of the corresponding pressing roll 62. In this example, in FIG. 4, the press cylinder 71 at the left of the electrode sheet 10 will also be referred to as a press cylinder 71L, and the press cylinder 71 at the right of the electrode sheet 10 will also be referred to as a press cylinder 71R. In description common to the press cylinders 71L and 71R, the term “press cylinder 71” will also be used. In this preferred embodiment, the press cylinders 71 are pneumatic cylinders. The press cylinders 71 include rods 71a. The rods 71a are connected to the roll chocks 72. The roll chocks 72 rotatably support the both axial portions 62b of the pressing rolls 62. When the press cylinders 71 are driven and the rods 71a move downward, the pressing rolls 62 move downward. With the downward movement of the pressing rolls 62, the pressing rolls 62 are pressed by the support roll 61, and the pressing force increases. When the press cylinders 71 are driven and the rods 71a move upward, the pressing rolls 62 move upward. The upward movement of the pressing rolls 62 reduces the pressing force.

The cylinder driver 73 presses the pressing rolls 62 against the support roll 61. The cylinder driver 73 is connected to the press cylinders 71. The cylinder driver 73 drives the press cylinders 71. In this manner, the rods 71a of the press cylinders 71 move upward and downward. In this preferred embodiment, the cylinder driver 73 is configured to drive the press cylinder 71L and the press cylinder 71R independently of each other. That is, the cylinder driver 73 drives the pressing rolls 62 located above the uncoated portions 12a at both ends of the electrode sheet 10 in the width direction, independently of each other. The cylinder driver 73 is connected to the controller 100 (see FIG. 3).

In this preferred embodiment, the press cylinders 71 is switchable between on and off by the cylinder driving device 73. While the press cylinders 71 are off, the cylinder driving device 73 is not driven, and the pressing rolls 62 are not pressed against the electrode sheet 10 by the press cylinders 71. While the press cylinders 71 are on, the cylinder driving device 73 is driven, and the pressing rolls 62 are pressed against the electrode sheet 10 by the cylinder driving device 73 and the press cylinders 71.

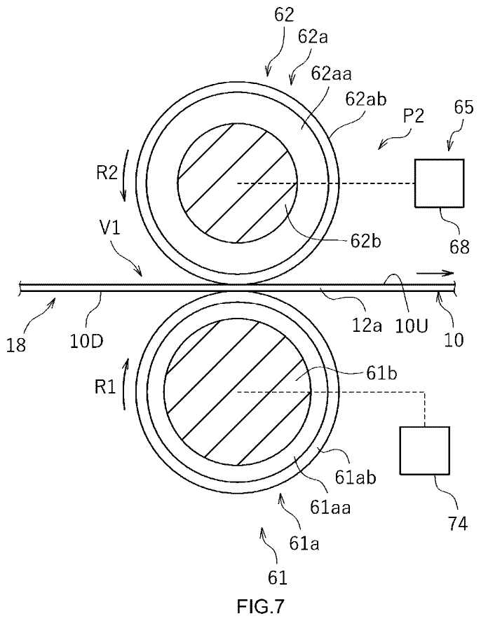

FIG. 7 illustrates a state where the pressing rolls 62 are located at the second position P2 and the press cylinders 71 are off, and corresponds to FIG. 5. In this example, when the pressing rolls 62 are at the second position P2, the press cylinders 71 are switched between on and off. As illustrated in FIG. 7, in a case where the press cylinders 71 are off when the pressing rolls 62 are at the second position P2, for example, the pressing rolls 62 are not pressed against the electrode sheet 10 by the press cylinders 71 and are mounted on the electrode sheet 10 supported by the support roll 61. At this time, the pressing rolls 62 can be pressed against the electrode sheet 10 to some degree by self weight. In this example, in the case where the pressing rolls 62 are at the second position P2 and the press cylinders 71 are off, the pressing rolls 62 are pressed against the electrode sheet 10 with a predetermined first load value V1. The first load value V1 is not limited to a particular value, and is, for example, 800 N or less.

As illustrated in FIG. 5, in a case where the pressing rolls 62 are at the second position P2 and the press cylinders 71 are on, for example, the pressing rolls 62 become the state of being pressed against the electrode sheet 10 by the press cylinders 71 by driving of the cylinder driving device 73. In this example, in the case where the pressing rolls 62 are at the second position P2 and the press cylinders 71 are on, the pressing rolls 62 are pressed against the electrode sheet 10 with a predetermined second load value V2. The second load value V2 is larger than the first load value V1. The second load value V2 is not limited to a particular value, and is, for example, 1000 N to 4000 N and may be 2000 N to 3000 N. The second load value V2 is about 10 to 80 times as large as the first load value V1, and is, for example, about 10 to 30 times as large as the first load value V1. The relationship in magnitude between the first load value V1 and the second load value V2 can change depending on a specific value of the first load value V1.

In this preferred embodiment, as illustrated in FIG. 4, the electrode sheet fabrication device 1 includes a rotation mechanism 74 and supporters 75. The rotation mechanism 74 rotates the support roll 61. The rotation mechanism 74 is connected to the support roll 61. In this preferred embodiment, the rotation mechanism 74 rotates the support roll 61 in the direction of arrow R1 in FIG. 5. It should be noted that the rotation mechanism 74 may rotate the support roll 61 in the direction opposite to the direction of arrow R1. The rotation mechanism 74 is not limited to a particular configuration, and is constituted by an electric motor and gears, for example. The rotation mechanism 74 is connected to the controller 100 (see FIG. 3).

The supporters 75 support the support roll 61. The supporters 75 support the both axial portions 61b of the support roll 61.

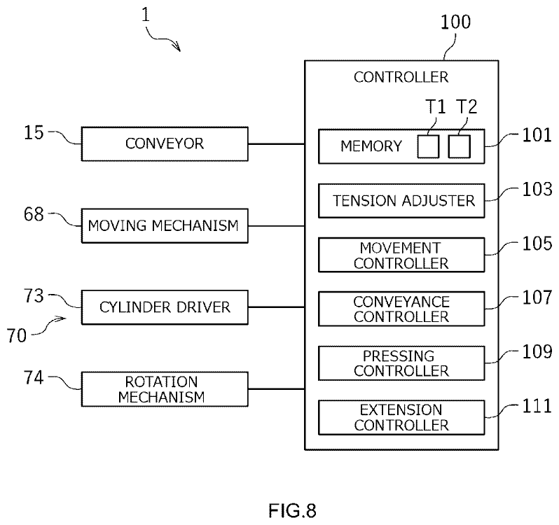

The controller 100 illustrated in FIG. 3 controls the roll pressing machine 60 as described above. The configuration of the controller 100 is not particularly limited. The controller 100 is, for example, a microcomputer. A hardware architecture of the microcomputer is not particularly limited, and includes, for example, an I/F, a CPU, a ROM, a RAM, and a memory device. FIG. 8 is a block diagram of the electrode sheet fabrication device 1. As illustrated in FIG. 8, the controller 100 is communicably connected to, for example, the conveyor 15, the moving mechanism 68, and the pressing mechanism 70 (specifically, the cylinder driver 73), and the rotation mechanism 74. The controller 100 controls the conveyor 15, the moving mechanism 68, the pressing mechanism 70, and the rotation mechanism 74.

The electrode sheet fabrication device 1 according to this preferred embodiment has been described above. As described above, the pressing rolls 62 are rubber rolls at least whose outer circumference surfaces are made of rubber. Thus, as illustrated in FIG. 5, when the pressing rolls 62 are pressed against the electrode sheet 10, the outer circumference surfaces of the pressing rolls 62 are easily deformed. In particular, portions of the outer circumference surfaces of the pressing rolls 62 pressed against the electrode sheet 10 can be deformed. The deformed portions of the pressing rolls 62 can become flat along the shape of the electrode sheet 10. If the pressing rolls 62 do not rotate and are kept pressed against the electrode sheet 10 for a long time, the deformed portions of the pressing rolls 62 can be permanently deformed. If the pressing rolls 62 in such a partially deformed state (e.g., permanently deformed state) rotate and are pressed against the electrode sheet 10 to extend the uncoated portions 12a of the electrode sheet 10, these portions cannot be uniformly extended in some cases. For example, portions of the uncoated portions 12a pressed by the deformed portions of the pressing rolls 62 can extend to a small degree, as compared to portions of the uncoated portions 12a pressed by non-deformed portions of the pressing rolls 62. Consequently, it can be difficult to extend the uncoated portions 12a uniformly.

In addition, if the pressing rolls 62 do not rotate and are kept pressed against the electrode sheet 10 for a long time so that pressed portions of the pressing rolls 62 are thereby permanently deformed, the uncoated portions 12a of the electrode sheet 10 can extend excessively accordingly. Consequently, the excessively extended uncoated portions 12a of the electrode sheet 10 can be broken.

Further, if the pressing rolls 62 are pressed against the electrode sheet 10 to sandwich the electrode sheet 10 therebetween with the support roll 61 rotated by the rotation mechanism 74, a difference in rotation speed between the support roll 61 and the pressing rolls 62 can hinder appropriate extension of the uncoated portions 12a (e.g., can break the uncoated portions 12a).

In view of this, in this preferred embodiment, to extend the uncoated portions 12a as uniformly as possible, a predetermined pretreatment is controlled by the controller 100 before the uncoated portions 12a of the electrode sheet 10 is extended. In this preferred embodiment, as illustrated in FIG. 8, the controller 100 includes a memory 101, a tension adjuster 103, a movement controller 105, a conveyance controller 107, a pressing controller 109, and an extension controller 111. Each unit of the controller 100 may be implemented by one or more processors or a circuit.

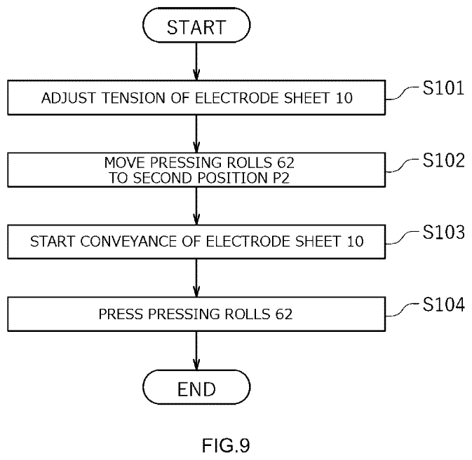

Next, the pretreatment performed before the uncoated portions 12a of the electrode sheet 10 are pressed by the roll pressing machine 60 and extended will be described with reference to the flowchart of FIG. 9. As illustrated in FIG. 6, this pretreatment starts when the support roll 61 supports the electrode sheet 10 and the pressing rolls 62 are at the first position P1. At the start of the pretreatment, the pressing rolls 62 are not in contact with the electrode sheet 10 supported by the support roll 61 and are separated from the electrode sheet 10 and located above the electrode sheet 10. At the start of the pretreatment, the conveyor 15 is not driven, and the electrode sheet 10 is not conveyed.

In the pretreatment, first, in step S101 of FIG. 9, the tension adjuster 103 shown in FIG. 8 adjusts a tension of the electrode sheet 10. In this step, the tension adjuster 103 adjusts the tension of the electrode sheet 10 supported by the support roll 61. As illustrated in FIG. 3, the electrode sheet 10 supported by the support roll 61 is bridged across the unwinding roll 15a and the winding roll 15b of the conveyor 15. Thus, the tension adjuster 103 adjusts the tension of the electrode sheet 10 between the unwinding roll 15a and the winding roll 15b. In this step, the tension adjuster 103 adjusts the conveyor 15 (e.g., rotation of the unwinding roll 15a or the winding roll 15b) such that the tension of the electrode sheet 10 reaches a predetermined reference tension. The reference tension is a tension of the electrode sheet 10 when the roll pressing machine 60 presses the uncoated portions 12a. The reference tension is stored in the memory 101 in FIG. 8 beforehand. In adjusting the tension of the electrode sheet 10 by the tension adjuster 103, the electrode sheet 10 is not sandwiched between the support roll 61 and the pressing rolls 62. At this time, the pressing rolls 62 are located above the electrode sheet 10 and separated from the electrode sheet 10.

Then, in step S102 of FIG. 9, the movement controller 105 shown in FIG. 8 moves the pressing rolls 62 (both the pressing rolls 62L and 62R in this step) to the second position P2 (see FIG. 7). In step S102, the tension of the electrode sheet 10 supported by the support roll 61 is set at the reference tension, but the electrode sheet 10 is not conveyed yet. Before step S102 is performed, the pressing rolls 62 are at the first position P1 as illustrated in FIG. 6. Before the conveyor 15 starts conveyance of the electrode sheet 10, the movement controller 105 moves the pressing rolls 62 from the first position P1 toward the second position P2. In this step, as illustrated in FIG. 7, the movement controller 105 controls the moving mechanism 68 to move the pressing rolls 62 downward so that the pressing rolls 62 thereby move to the second position P2. In moving the pressing rolls 62 to the second position P2, the movement controller 105 turns the press cylinders 71 off, that is, does not drive the cylinder driving device 73. When the pressing rolls 62 are moved to the second position P2, the movement controller 105 turns the press cylinders 71 off. The movement controller 105 moves the pressing rolls 62 to the second position P2 such that the pressing rolls 62 are pressed against the electrode sheet 10 with the first load value V1 (see FIG. 7) at the second position P2.

In this manner, when the pressing rolls 62 move to the second position P2 by the movement controller 105, the pressing rolls 62 contact the second surface 10U of the electrode sheet 10 but are mounted on the electrode sheet 10 by self weight of the pressing rolls 62. At this time, the pressing rolls 62 are in the state of being pressed against the electrode sheet 10 with the first load value V1 by self weight.

Thereafter, in step S103 of FIG. 9, the conveyance controller 107 illustrated in FIG. 8 conveys the electrode sheet 10 along the support roll 61. Here, as illustrated in FIG. 7, in the state where the pressing rolls 62 are at the second position P2 and the press cylinders 71 are off, the conveyance controller 107 starts conveyance of the electrode sheet 10 to the downstream side in the conveyance path 18. In this step, the conveyance controller 107 conveys the electrode sheet 10 by controlling the conveyor 15 (see FIG. 3), and rotates the support roll 61 in the direction of arrow R1 to thereby convey the electrode sheet 10 by controlling the rotation mechanism 74. In this preferred embodiment, in step S103, the pressing rolls 62 are pressed against the electrode sheet 10 by self weight. Thus, in conveying the electrode sheet 10, the pressing rolls 62 rotate in the direction of arrow R2 in synchronization with rotation of the support roll 61. The rotation speed of the support roll 61 at this time is equal to the rotation speed of the pressing rolls 62.

In this preferred embodiment, when a predetermined standby time T1 (see FIG. 8) has elapsed since the pressing rolls 62 moved to the second position P2 by the movement controller 105, the conveyance controller 107 conveys the electrode sheet 10 along the support roll 61. The standby time T1 is stored in the memory 101 (see FIG. 8) beforehand. The standby time T1 is not limited to a particular value, and is, for example, 0.1 second to 10 seconds.

After the conveyance of the electrode sheet 10 has started in the manner describe above, step S104 of FIG. 9 is performed next. In step S104, as illustrated in FIG. 5, the pressing controller 109 in FIG. 8 presses the pressing rolls 62 against the electrode sheet 10. In this step, the pressing controller 109 presses the pressing rolls 62 against the electrode sheet 10 from the second position P2. Specifically, the pressing controller 109 drives the cylinder driving device 73 to turn the press cylinders 71 on from the off state. Accordingly, the pressing rolls 62 move downward so that the pressing rolls 62 are thereby pressed against the electrode sheet 10 with the second load value V2.

In this preferred embodiment, when a predetermined reference time T2 (see FIG. 8) has elapsed since conveyance of the electrode sheet 10 by the conveyance controller 107 started, the pressing controller 109 performs control such that the pressing rolls 62 are pressed against the electrode sheet 10 from the second position P2. The reference time T2 is stored in the memory 101 of FIG. 8 beforehand. The reference time T2 is not limited to a particular value, and is, for example, three seconds or less, preferably one second or less. The reference time T2 is, for example, 0.1 second. The reference time T2 may be set in accordance with the rotation speed of the pressing rolls 62. For example, the reference time T2 may be a time necessary for the pressing rolls 62 to make one turn in conveying the electrode sheet 10 by the conveyor 15.

The reference time T2 may be zero. In the case where the reference time T2 is zero, when conveyance of the electrode sheet 10 by the conveyance controller 107 is started, the pressing controller 109 presses the pressing rolls 62 against the electrode sheet 10 from the second position P2. In this manner, the timing of starting conveyance of the electrode sheet 10 by the conveyance controller 107 may coincide with the timing of starting pressing the pressing rolls 62 against the electrode sheet 10 by the pressing controller 109.

The pretreatment is performed in the manner described above. After the pretreatment has been performed, the extension controller 111 in FIG. 8 causes the roll pressing machine 60 to press and extend the uncoated portions 12a of the electrode sheet 10. In this example, as illustrated in FIG. 5, the extension controller 111 turns the press cylinders 71 on to press the pressing rolls 62 against the electrode sheet 10 with the second load value V2, and controls the conveyor 15 (see FIG. 3) and the rotation mechanism 74 to transfer the electrode sheet 10 to the downstream side in the conveyance path 18 (see FIG. 3). In this manner, the uncoated portions 12a of the electrode sheet 10 are pressed with the second load value V2 and extended while being sandwiched between the support roll 61 and the pressing rolls 62.

As described above, in this preferred embodiment, the electrode sheet fabrication device 1 is a fabrication device for fabricating the electrode sheet 10. As illustrated in FIG. 2, the electrode sheet 10 includes the current collector 12 of long metal foil, the uncoated portions 12a defined along the length direction at a predetermined position in the width direction in the current collector 12, and the electrode active material layer 14 located on a portion of the current collector 12 except for the uncoated portions 12a and including the electrode active material. As illustrated in FIGS. 3 and 4, the electrode sheet fabrication device 1 includes the conveyor 15, the support roll 61, the pressing rolls 62, the driver 65, and the controller 100. The conveyor 15 conveys the long electrode sheet 10 along the predetermined conveyance path 18. The support roll 61 that is located on the conveyance path 18 and supports, along the width direction, the first surface 10D of the electrode sheet 10 conveyed along the conveyance path 18. The pressing rolls 62 are located on the second surface 10U of the electrode sheet 10 and face the support roll 61. The driver 65 presses the pressing rolls 62 against the support roll 61 with the electrode sheet 10 sandwiched therebetween. As illustrated in FIG. 5, the pressing rolls 62 are rubber rolls at least whose outer circumference surfaces are made of rubber, and are located such that the uncoated portions 12a are sandwiched between the pressing rolls 62 and the support roll 61 except for the electrode active material layer 14 of the electrode sheet 10. As illustrated in FIG. 4, the driver 65 includes the moving mechanism 68 and the pressing mechanism 70. The moving mechanism 68 moves the pressing rolls 62 to the first position P1 (see FIG. 6) at which the pressing rolls 62 are separated from the electrode sheet 10 and the second position P2 (see FIG. 7) at which the pressing rolls 62 contact the electrode sheet 10. As illustrated in FIG. 5, the pressing mechanism 70 presses the pressing rolls 62 against the electrode sheet 10 from the second position P2. As illustrated in FIG. 8, the controller 100 includes the movement controller 105, the conveyance controller 107, and the pressing controller 109. As described in step S102 of FIG. 9, the movement controller 105 moves the pressing rolls 62 from the first position P1 toward the second position P2 before the conveyor 15 starts conveyance of the electrode sheet 10. After the pressing rolls 62 has moved to the second position P2 by the movement controller 105, the conveyance controller 107 conveys the electrode sheet 10 along the support roll 61, as described in step S103 of FIG. 9. When the predetermined reference time T2 (see FIG. 8) has elapsed since conveyance of the electrode sheet 10 by the conveyance controller 107 started, the pressing controller 109 presses the pressing rolls 62 against the electrode sheet 10 from the second position P2, as described in step S104 of FIG. 9. Alternatively, when conveyance of the electrode sheet 10 by the conveyance controller 107 is started, the pressing controller 109 may press the pressing rolls 62 against the electrode sheet 10 from the second position P2.

In this preferred embodiment, as illustrated in FIG. 7, after the pressing rolls 62 have been placed at the second position P2, conveyance of the electrode sheet 10 starts. Then, when conveyance of the electrode sheet 10 starts or when the reference time T2 has elapsed since conveyance of the electrode sheet 10 started, the pressing rolls 62 are pressed against the electrode sheet 10 from the second position P2, as illustrated in FIG. 5. Thus, since the timing of pressing the pressing rolls 62 against the electrode sheet 10 from the second position P2 can be delayed, the pressing rolls 62 are less likely to be locally deformed. Accordingly, the uncoated portions 12a of the electrode sheet 10 can be pressed by using the pressing rolls 62 that are less likely to be locally deformed and the support roll 61, and thus, the uncoated portions 12a can be easily extended uniformly.

In this preferred embodiment, as illustrated in FIG. 7, the movement controller 105 moves the pressing rolls 62 to the second position P2 such that the pressing rolls 62 is pressed against the electrode sheet 10 with the predetermined first load value V1 at the second position P2. The pressing controller 109 presses the pressing rolls 62 against the electrode sheet 10 with the second load value V2 (see FIG. 5) larger than the first load value V1. Accordingly, when the pressing rolls 62 move from the first position P1 to the second position P2 by the movement controller 105, pressure in pressing the pressing rolls 62 against the electrode sheet 10 can be reduced. As a result, the pressing rolls 62 are less likely to be locally deformed at the second position P2.

In this preferred embodiment, as illustrated in FIG. 4, the pressing mechanism 70 includes the press cylinders 71 that presses the pressing rolls 62 against the electrode sheet 10 by turning the pressing mechanism 70 on. The movement controller 105 turns the press cylinders 71 off when the pressing rolls 62 are moved to the second position P2. The pressing controller 109 presses the pressing rolls 62 against the electrode sheet 10 from the second position P2 by turning the press cylinders 71 on, as illustrated in FIG. 5. In this manner, by switching the press cylinders 71 from off to on, the timing of pressing the pressing rolls 62 against the electrode sheet 10 from the second position P2 can be controlled.

In this preferred embodiment, as illustrated in FIG. 4, the electrode sheet fabrication device 1 includes the rotation mechanism 74 that rotates the support roll 61. As illustrated in FIG. 7, the conveyance controller 107 rotates the support roll 61 to thereby start conveyance of the electrode sheet 10 along the support roll 61. In this manner, the support roll 61 is rotated in conveying the electrode sheet 10 so that the pressing rolls 62 can be easily rotated in synchronization with rotation of the support roll 61. Accordingly, portions to be pressed against the electrode sheet 10 by the pressing rolls 62 can be changed by rotation of the pressing rolls 62 so that the pressing rolls 62 are thereby less likely to be locally deformed.

In this preferred embodiment, when the predetermined standby time T1 (see FIG. 8) has elapsed since the pressing rolls 62 moved to the second position P2 by the movement controller 105, the conveyance controller 107 conveys the electrode sheet 10 along the support roll 61. For example, in a case where the electrode sheet 10 is conveyed at the same time as movement of the pressing rolls 62 to the second position P2 or the electrode sheet 10 is conveyed before movement of the pressing rolls 62 to the second position P2, when the pressing rolls 62 contact the uncoated portions 12a of the electrode sheet 10, a pressure is likely to be applied to the current collector 12 exposed in the uncoated portions 12a so that crease or other problems occur to cause deformation in some cases. However, in this preferred embodiment, the electrode sheet 10 is conveyed after the standby time T1 has elapsed since the pressing rolls 62 moved to the second position P2. Thus, conveyance of the electrode sheet 10 can be started after the pressing rolls 62 have contacted the uncoated portions 12a. Accordingly, the uncoated portions 12a are relatively less subjected to pressure from the pressing rolls 62, and thus, the uncoated portions 12a are less likely to be deformed.

In the preferred embodiment, the pressing rolls 62 are located above the support roll 61. Alternatively, the pressing rolls 62 may be located below the support roll 61. In this case, the pressing rolls 62 may be configured to sandwich the electrode sheet 10 together with the support roll 61 by moving upward. In this case, the first surface of the electrode sheet 10 supported by the support roll 61 is the upper surface of the electrode sheet 10. The second surface of the electrode sheet 10 contacting the pressing rolls 62 is the lower surface of the electrode sheet 10.

Various examples of the present disclosure has been described. The present disclosure is not limited to, for example, the preferred embodiment described here unless otherwise specified. The preferred embodiment disclosed here can be modified in various ways, and the constituent elements and the processes described here can be appropriately omitted or appropriately combined unless no particular problems arise.

As described above, the specification includes the disclosures described in the following items.

### Item 1

An electrode sheet fabrication device that fabricates an electrode sheet including a current collector of long metal foil, a non-formed portion defined along a length direction at a predetermined position in a width direction in the current collector, and an electrode active material layer located on a portion of the current collector except for the non-formed portion and including an electrode active material, and the fabrication device includes:

a conveyor that conveys the electrode sheet along a predetermined conveyance path;

a support roll that is located on the conveyance path and supports, along the width direction, a first surface of the electrode sheet conveyed along the conveyance path;

a pressing roll located at a second surface of the electrode sheet and facing the support roll;

a driver that presses the pressing roll against the support roll with the electrode sheet sandwiched between the pressing roll and the support roll; and

a controller, wherein

the pressing roll is a rubber roll at least whose outer circumference surface is made of rubber and is located such that the non-formed portion is sandwiched between the pressing roll and the support roll except for the electrode active material layer of the electrode sheet,

the driver includes
a moving mechanism that moves the pressing roll to a first position at which the pressing roll is separated from the electrode sheet and a second position at which the pressing roll contacts the electrode sheet, and
a pressing mechanism that presses the pressing roll against the electrode sheet from the second position, and

the controller includes
a movement controller that moves the pressing roll from the first position toward the second position before the conveyor starts conveyance of the electrode sheet,
a conveyance controller that conveys the electrode sheet along the support roll after the pressing roll has moved to the second position by the movement controller, and
a pressing controller that presses the pressing roll against the electrode sheet from the second position when the conveyance controller starts conveyance of the electrode sheet or when a predetermined reference time has elapsed since the conveyance controller started conveyance of the electrode sheet.

### Item 2

The electrode sheet fabrication device according to item 1, wherein

the movement controller moves the pressing roll to the second position such that the pressing roll is pressed against the electrode sheet with a predetermined first load value at the second position, and

the pressing controller presses the pressing roll against the electrode sheet with a second load value larger than the first load value.

### Item 3

The electrode sheet fabrication device according to item 1 or 2, wherein

the pressing mechanism includes a press cylinder that presses the pressing roll against the electrode sheet by turning on the press cylinder,

the movement controller turns the press cylinder off when the pressing roll moves to the second position, and

the pressing controller presses the pressing roll against the electrode sheet from the second position by turning the press cylinder on.

### Item 4

The electrode sheet fabrication device according to any one of items 1 to 3, wherein the pressing controller presses the pressing roll against the electrode sheet from the second position when the reference time has elapsed since the conveyance controller started conveyance of the electrode sheet.

### Item 5

The electrode sheet fabrication device according to any one of items 1 to 4, further includes a rotation mechanism that rotates the support roll, and

the conveyance controller starts conveyance of the electrode sheet along the support roll by rotating the support roll.

### Item 6

The electrode sheet fabrication device according to any one of item 1 to 5, wherein the conveyance controller conveys the electrode sheet along the support roll when a predetermined standby time has elapsed since the pressing roll moved to the second position by the movement controller.

What is claimed is:

1. An electrode sheet fabrication device that fabricates an electrode sheet including a current collector of long metal foil, a non-formed portion defined along a length direction at a predetermined position in a width direction in the current collector, and an electrode active material layer located on a portion of the current collector except for the non-formed portion and including an electrode active material, the fabrication device comprising:
a conveyor that conveys the electrode sheet along predetermined conveyance path;
a support roll that is located on the conveyance path and supports, along the width direction, a first surface of the electrode sheet conveyed along the conveyance path;
a pressing roll located at a second surface of the electrode sheet and facing the support roll;
a driver that presses the pressing roll against the support roll with the electrode sheet sandwiched between the pressing roll and the support roll; and
a controller, wherein
the pressing roll is a rubber roll at least whose outer circumference surface is made of rubber and is located such that the non-formed portion is sandwiched between the pressing roll and the support roll except for the electrode active material layer of the electrode sheet,
the driver includes
a moving mechanism that moves the pressing roll to a first position at which the pressing roll is separated from the electrode sheet and a second position at which the pressing roll contacts the electrode sheet, and
a pressing mechanism that presses the pressing roll against the electrode sheet from the second position, and
the controller includes
a movement controller that moves the pressing roll from the first position toward the second position before the conveyor starts conveyance of the electrode sheet,
a conveyance controller that conveys the electrode sheet along the support roll after the pressing roll has moved to the second position by the movement controller, and
a pressing controller that presses the pressing roll against the electrode sheet from the second position when the conveyance controller starts conveyance of the electrode sheet or when a predetermined reference time has elapsed since the conveyance controller started conveyance of the electrode sheet.

2. The electrode sheet fabrication device according to claim 1, wherein
the movement controller moves the pressing roll to the second position such that the pressing roll is pressed against the electrode sheet with a predetermined first load value at the second position, and
the pressing controller presses the pressing roll against the electrode sheet with a second load value larger than the first load value.

3. The electrode sheet fabrication device according to claim 1, wherein
the pressing mechanism includes a press cylinder that presses the pressing roll against the electrode sheet by turning on the press cylinder,
the movement controller turns the press cylinder off when the pressing roll moves to the second position, and
the pressing controller presses the pressing roll against the electrode sheet from the second position by turning the press cylinder on.

4. The electrode sheet fabrication device according to claim 1, wherein the pressing controller presses the pressing roll against the electrode sheet from the second position when the reference time has elapsed since the conveyance controller started conveyance of the electrode sheet.

5. The electrode sheet fabrication device according to claim 1, further comprising a rotation mechanism that rotates the support roll, wherein
the conveyance controller starts conveyance of the electrode sheet along the support roll by rotating the support roll.

6. The electrode sheet fabrication device according to claim 1, wherein the conveyance controller conveys the electrode sheet along the support roll when a predetermined standby time has elapsed since the pressing roll moved to the second position by the movement controller.
